(19) United States
(12) Patent Application Publication
(10) Pub. No.: US 2021/0026897 A1
(43) Pub. Date: Jan. 28, 2021

(54) TOPICAL CLUSTERING AND NOTIFICATIONS FOR DRIVING RESOURCE COLLABORATION

(71) Applicant: Microsoft Technology Licensing, LLC, Redmond, WA (US)

(72) Inventors: William John Rathje, Seattle, WA (US); Raju Jain, Kirkland, WA (US); Gregory Thomas Mattox, JR., Bellevue, WA (US); Brent Edward Ford, Issaquah, WA (US); Anshul Rawat, Kirkland, WA (US); Elizabeth Picchietti Salowitz, Kirkland, WA (US); Brandon Holmes Paddock, Seattle, WA (US); Jeffrey Jay Johnson, Bellevue, WA (US)

(21) Appl. No.: 16/519,335

(22) Filed: Jul. 23, 2019

(51) Int. Cl. G06F 16/9032; G06F 16/9035; G06F 16/906; G06N 7/00; G06K 9/62; G06F 17/20; G06F 16/93

(52) U.S. Cl. CPC G06F 16/90332; G06F 16/9035; G06F 16/906; G06F 16/93; G06K 9/6277; G06F 17/20; G06N 7/005

(57) ABSTRACT

In non-limiting examples of the present disclosure, systems, methods and devices for surfacing collaborative recommendations in relation to topically classified resources are presented. Resources may be topically classified based on application of natural language processing and machine learning models. Relationships amongst users that own, authored and/or edited the resources may be identified. Recommendations may be surfaced based on topical and/or user characteristic overlap associated with the resources. The recommendations may relate to group collaboration on resource creation, sharing of related resources, incorporating related resources in existing resources, and/or recommending group creation and/or collaboration associated with resource topics.

### BACKGROUND

It is common for users to collaborate on document creation by sending documents back and forth electronically and/or via the utilization of a cloud-based document editing service. Users generally only initiate such collaboration based on in-person communications (e.g., being assigned to a same group in a class, being assigned to a same team at work). However, users working on projects incorporated in documents and other resources may not identify that other users may be working on projects that are closely related to their own, or that they have already created and/or collected resources that may be useful in completion of a current project.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for surfacing collaborative recommendations in relation to topically classified resources. Natural language processing and machine learning models may be applied to resources (e.g., documents, presentations, videos) and those resources may be topically classified based on that processing. Users associated with the resources may be identified and characteristics associated with those users may be utilized to group the users and/or further classify the resources. In some examples, the processing of resources may be utilized to create relationships and/or edges between a resource and previously classified resources/nodes in an existing graphical resource matrix. The topical relationships between resources and/or the characteristic-based relationships between users associated with resources may be utilized for surfacing collaborative recommendations related to the resources and users.

### BRIEF DESCRIPTION OF THE DRAWINGS

Non-limiting and non-exhaustive examples are described with reference to the following figures:

FIG. 1 is a schematic diagram illustrating an example distributed computing environment for surfacing collaborative recommendations in relation to topically classified resources.

FIG. 2 illustrates a computing device displaying an email user interface including a collaborative resource recommendation pane.

FIG. 3 illustrates a word processing user interface including a collaborative resource recommendation pane that can be interacted with for opening and reviewing a resource that is topically related to a document displayed in the word processing user interface.

FIG. 4 illustrates a word processing user interface including a collaborative resource recommendation pane that can be interacted with for tagging a document based on its topical classification.

FIG. 5 illustrates a computing device displaying an email user interface including a collaborative resource pane that can be interacted with for surfacing and sharing resources that are topically related to an email displayed in the email user interface.

FIG. 6 is an exemplary method for sharing collaborative documents.

FIG. 7 is an exemplary method for recommending group collaboration.

FIG. 8 is an exemplary method for assisting with sharing collaborative documents.

FIGS. 9 and 10 are simplified diagrams of a mobile computing device with which aspects of the disclosure may be practiced.

FIG. 11 is a block diagram illustrating example physical components of a computing device with which aspects of the disclosure may be practiced.

FIG. 12 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Non-limiting examples of the present disclosure describe systems, methods and devices for surfacing collaborative recommendations in relation to topically classified resources. According to examples, a resource collaboration service may be provided with access to a plurality of resources (e.g., documents, audio, video, etc.) of one or more resource and/or application types. The resource collaboration service may additionally or alternatively have access to user information corresponding to one or more characteristics associated with the owners, authors and/or editors of resources. In some examples, the resource collaboration service may apply one or more natural language processing and/or machine learning models to the resources and topically classify the resources based on the application of those models. Various natural language processing models, including topic detection and clustering models, are described herein which may be utilized to topically classify text in electronic documents. Various machine learning models, such as neural networks, are described herein which may be utilized to topically classify images and other embedded objects in electronic documents.

Topical classifications and/or user characteristics (e.g., owner, author, and/or editor characteristics) may be associated with the electronic resources as attributes. The attributes may be searchable. In some examples, the resources may be associated/included in a graphical resource matrix comprised of resource nodes and edges. The edges may comprise relationships between the resources in the matrix (e.g., users in common, characteristics of users in common, classification types in common, tasks in common, etc.). In other examples, the attributes and characteristics of users may be searchable via one or more resource and attribute lookup tables.

In some examples, the resource collaboration service may provide recommendations that users collaborate on resources and topics based on determining that those users are working on documents that share topical classifications and/or that those users share one or more characteristics. In other examples, the resource collaboration service may provide recommendations that users share documents with other users based on determining that those users are working on documents that share topical classifications, based on determining that those users share one or more characteristics, and/or based on determining that a sharing user has previously shared one or more documents that have topical overlap with a document that has not been shared. In additional examples, the resource collaboration service may provide recommendations that users open, preview and/or incorporate subject matter from a document that shares a topical overlap with another document. In some examples, the resource collaboration service may provide recommendations to users that work in a same organization or company to collaborate on documents with one another. In additional examples, the resource collaboration service may provide recommendations to users that are in a same educational institution to collaborate on documents with one another. In other examples, the resource collaboration service may provide recommendations to users that are related via one or more online connections (e.g., social networking connections, electronic address book connections) to collaborate on documents with one another. In additional examples, the resource collaborations service may provide recommendation to unrelated users to collaborate on documents with one another. In some examples, the resource collaboration service may provide recommendations that users collaborate, create new groups and/or join existing groups based on determining that users share characteristics and/or determining that resources have topical overlap.

In some examples, the resource collaboration service may provide recommendations that users collaborate on resources, share documents with one another, open, preview and/or incorporate subject matter from documents, and/or recommend that users collaborate and create new groups and/or join existing groups based on clustering documents via application of one or more language processing and/or machine learning models. That is, in addition or alternatively to topically classifying documents, linguistic features may be extracted from documents via a language processing model and a weight value and/or score value may be assigned to the extracted features based on the output of the language processing model. One or more additional documents may then be identified from an available corpus by determining a numeric representation of the similarity (a similarity score) between individual items, between an item and a group of items, and/or between one group of items an another group of items, whereby the similarity score is determined by comparing the extracted features and weight values produced via application of the language processing model.

In some examples features from a document may be scored, and subsequently compared against other feature document scores via feature extraction and scoring tokens/words and/or bigrams from the document (e.g., token extraction including stemming and other pre-processing, weights assigned based on occurrences, capitalization, TF-IDF-reducing the weight given to tokens which appear frequently across a corpus, part-of-speech tagging, special context, search terms, title fields, etc.). According to some examples, a similarity score may be generated by comparing tokens and weights of documents versus those of other documents, where other metadata (e.g., time distance for creation, edit/engagement sessions, whether documents were accessed by the same user, by the same device, etc.) may be factored into the score. In additional examples, one or more of the items may be clustered together if a threshold similarity score is calculated for those items. In some examples, only the items with the highest similarity score in a first pass may be clustered. In additional examples, only items for which no disqualifying characteristics are detected may be clustered. In some examples, upon merging items into a cluster, those items' assigned weights and metadata values may be combined and aggregates computed. In examples, this process may be repeated, whereby unclustered items and clusters generated in the first pass may be compared against other items or clusters, generating a new similarity score, and merging the compared items/clusters into new clusters if the score exceeds a specified threshold. Thus, in some examples, collaboration on documents may be recommended for documents that share a threshold number of clustered items and/or clustered features, and/or for which a threshold similarity score has been determined based on the clustering of items and/or features in those documents.

The systems, methods, and devices described herein provide technical advantages for surfacing collaborative recommendations in relation to topically classified resources. Processing costs (i.e., CPU cycles) are reduced via the mechanisms described herein at least in that resources can be automatically topically classified and cross-referenced via application of natural language processing and/or machine learning models and/or execution of search functions in a graphical resource matrix. Rather than requiring users to manually classify resources so that they can be searched and retrieved via those classifications, topical and characteristic-based attributes may be automatically assigned to resources so that relationships amongst those resources and the users that own and/or author those resources may be quickly and efficiently ascertained. The user experience associated with document-based work projects is also enhanced via the mechanisms described herein. By automatically identifying relationships amongst resources and/or users associated with those resources, recommendations to collaborate on resources and/or in groups corresponding to topics of those resources may be surfaced without requiring users to communicate manually to ascertain that same information. Therefore, the messages required to identify overlapping themes in educational and work research projects amongst users is also reduced.

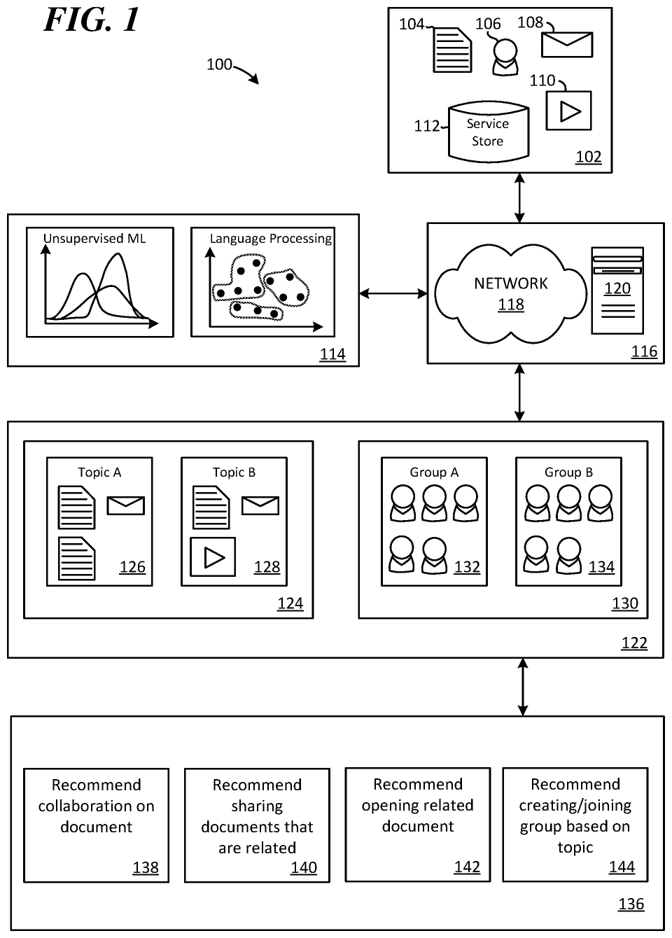

FIG. 1 is a schematic diagram illustrating an example distributed computing environment 100 for surfacing collaborative recommendations in relation to topically classified resources. Computing environment 100 includes service store sub-environment 102, network and processing sub-environment 116, language processing sub-environment 114, resource and user categorization sub-environment 122, and recommendation output sub-environment 136.

Network and processing sub-environment 116 includes network 118, by which any of the computing devices described herein may communicate with one another, and server computing device 120, which is exemplary of a cloud-computing device that may perform one or more operations described herein in relation to a cloud-based application service (e.g., a resource collaboration service, a suite of application services, etc.).

Service store sub-environment 102 comprises service store 112, which may contain information associated with a plurality of users' productivity applications, including documents 104 (e.g., word processing documents, spreadsheet documents, presentation documents, emails, webpages, etc.), user information 106, emails and other electronic messages 108, and videos and other digital media types 110, for example. Documents 104 may include productivity application documents that are stored locally to a local computing device associated with users associated with user information 106 and/or one or more remote storage locations. Server computing device 120 and an associated resource collaboration service may communicate with service store 112 and obtain and analyze information included therein in performing one or more operations described herein.

According to examples, the resources associated with service store 112 (and any other resources described herein) may be included in one or more graphical matrices comprised of nodes (i.e., resources) and corresponding edges (i.e., relationships between resources). The edges may be defined by attributes of each of the nodes. Attributes may comprise: temporal attributes, content type classification attributes (e.g., sports, dining, travel, academic—and subcategories therein), user attributes (e.g., editing users, authoring users, opening users, viewing users, etc.), and media/resource type attributes (e.g., word processing document, email, video, etc.), among others. According to some examples, one or more of the attributes, and therefore edges, that connect the resources in a matrix may be identified based on application of a natural language processing engine comprising one or more natural language processing and/or machine learning models, as illustrated by natural language processing and machine learning element 114. For example, language clustering models may be applied to text and/or audio in a resource to determine topical content type classifications that a resource, or portions thereof, may be classified in. In some examples, one or more neural networks may be utilized to classify non-textual information in a resource (e.g., to topically classify resources based on images).

According to examples, a natural language processing engine applied to a resource may be comprised of one or more layers and one or more processing models. In some examples, applying a natural language processing engine to a resource may comprise applying at least one of the following to the resource: topic detecting using clustering, hidden Markov models, maximum entropy Markov models, conditional random field models, support vector machine models, decision tree models, deep neural network models, general sequence-to-sequence models (e.g., conditional probability recurrent neural networks, transformer networks), generative models, recurrent neural networks for feature extractors (e.g., long short-term memory models, GRU models), deep neural network models for word-by-word classification, and latent variable graphical models. These models and the natural language processing engine described herein are generally illustrated by natural language processing and machine learning element 114.

Resource and user categorization sub-environment 122 includes topically categorized resources 124 and characteristic-based user categorization groups 130. For ease of illustration there are only two topically categorized resource groups in topically categorized resources 124. Those resource groups are Topic A resource group 126 and Topic B resource group 128. According to examples, the resources included in Topic A resource group 126 may have been topically categorized into a first topic type (e.g., a broad topic type such as “research paper” and/or one or more sub-categories of a primary category, such as research paper—biology—animal migration patterns—orcas, etc.). Similarly, the resources included in Topic B resource group 126 may have been topically categorized into a second topic type (e.g., a broad topic type such as “travel planning” and/or multiple sub-categories of a primary category, such as travel planning—summer vacation—Europe—Netherlands—Amsterdam, etc.). In examples, these topical categorizations may have been made via application of the language processing and/or machine learning models described above. In additional examples, these topical categorizations may be assigned to the resources in each topical resource group as attributes which correspond to nodes in a graphical matrix as also described above. In other examples, these topical categorizations may be utilized separate from the graphical matrix in recommending that users collaborate with one another in relation to one or more resources.

For ease of illustration there are only two groups of users that have been categorized based on their characteristics in characteristic-based user categorization groups 130. Those user groups are User Group A 132 and User Group B 134. According to examples, the resource collaboration service may have been granted access to information about users that utilize service store 112 associated with the resource collaboration service. In examples, user may have to explicitly opt in and provide permission to the resource collaboration service for the resource collaboration service to have access to the users' information. In some examples, users may define what information the resource collaboration service may have access to in relation to the users' accounts. The types of information that may be utilized to classify the users into different groups include, for example: educational information (e.g., an educational class of enrollment; an educational major of enrollment; an educational minor of enrollment; an area of educational instruction; a school of educational instruction; and a field of expertise), work information (e.g., work group, work level/hierarchy, etc.), locational information, age information, gender information, collaboration and other service-based preference information, etc. According to examples, these characteristic-based categorizations may be utilized in association with the topical categorizations to build edges and connect resources in a graphical matrix. In other examples, these characteristic-based categorizations may be utilized separate from the topical categorizations for recommending that users collaborate with one another in relation to one or more resources.

Recommendation output sub-environment 136 illustrates four different operational results that the resource collaboration service can provide via the processing described above. Specifically, recommendation output sub-environment 136 includes recommend collaboration on document element 138, recommend sharing documents that are related element 140, recommend opening related document element 142, and recommend creating/joining group based on topic element 144.

Recommend collaboration on document element 138 illustrates one possible operational result of the resource and user characteristic processing described above. For example, if a determination is made by the resource collaboration service that one or more users are related to one another to within a threshold value (e.g., percentage, ratio, number) based on shared characteristics, such as described above in relation to characteristic-based user categorization groups 130, the resource collaboration service may surface a recommendation in an application user interface of one or more of the users that the users collaborate on a document and/or project. In another example, if a determination is made by the resource collaboration service that one or more users' resources are related to one another to within a threshold value (e.g., percentage, ratio, number) based on shared attributes and/or edges, such as described above in relation to topically categorized resources 124, the resource collaboration service may surface a recommendation in an application user interface of one or more of the owners/authors of those resources that the owners/authors collaborate on the related resources. In still other examples, the determination of whether to surface a recommendation to collaborate on resources and/or corresponding projects may be based on a combination of a user characteristic-based value and a topically categorized resource value.

Recommend sharing documents that are related element 140 illustrates another possible operational result of the resource and user characteristic processing described above. For example, if a determination is made by the resource collaboration service that one or more users are related to one another to within a threshold value based on shared characteristics, such as described above in relation to characteristic-based user categorization groups 130, and the resource collaboration service determines that one or more resources of those users are related to one another to within a threshold value based on shared attributes and/or edges, such as described above in relation to topically categorized resources 124, the resource collaboration service may surface a recommendation in an application user interface of one or more of those users that they share the related documents with the related users. For example, if a first user is determined to share a threshold number of characteristics with a second user (e.g., same major of enrollment, same class of enrollment) and a document that the first user is an author of is determined to be related to within a threshold value of a document that the second user is an author of (e.g., they are connected by one or more topical attributes), the resource collaboration service may recommend that the first and second users share those documents with one another. In another example, if a first and second user have an electronic meeting with one another and the first user shares a first electronic document with the second user during the meeting, and a determination is made that a second document is related to the first document based on its attributes/edges, the resource collaboration service may recommend that the first user also share the second document with the second user.

Recommend opening related document element 142 illustrates a possible operational result of the resource processing described above. For example, if a determination is made by the resource collaboration service that one or more resources associated with a user (or multiple users) are related to one another to within a threshold value based on shared attributes and/or edges, such as described above in relation to topically categorized resources 124, the resource collaboration service may surface a recommendation in an application user interface of the user that the user open the related document(s) and/or incorporate the related document(s)' subject matter. For example, if a user is working on a word processing document that is determined to be categorized in content type A and a second document associated with that user is also determined to be categorized in content type A, the resource collaboration service may surface a prompt in the first document user interface indicating that the second document relates to the first document, and the prompt may be selectable for opening the second document and/or incorporating related subject matter from the second document into the first document.

Recommend creating/joining group based on topic element 144 illustrates another possible operational result of the resource and user characteristic processing described above. For example, if a determination is made by the resource collaboration service that one or more users are related to one another to within a threshold value based on shared characteristics, such as described above in relation to characteristic-based user categorization groups 130, and/or a determination is made that those related users are owners, authors and/or editors of resources that are topically related to one another to within a threshold value based on shared attributes and/or edges, such as described above in relation to topically categorized resources 124, the resource collaboration service may surface a recommendation in an application user interface of one or more of the users of those resources that the users should create and/or join a group to collaborate on resources together. For example, if a first user is determined to be related to a second user based on being in a same educational class, and a determination is made that both users are working on research project documents involving the same topic, the resource collaboration service may surface a recommendation that the two users create a group to work on the research project together. In another example, if a first user is determined to be related to a second user based on being in the same organization, and a determination is made that both users are working on work project resources related to solving a same or similar problem, the resource collaboration service may surface a recommendation that the two users create a group to work on the problem together.

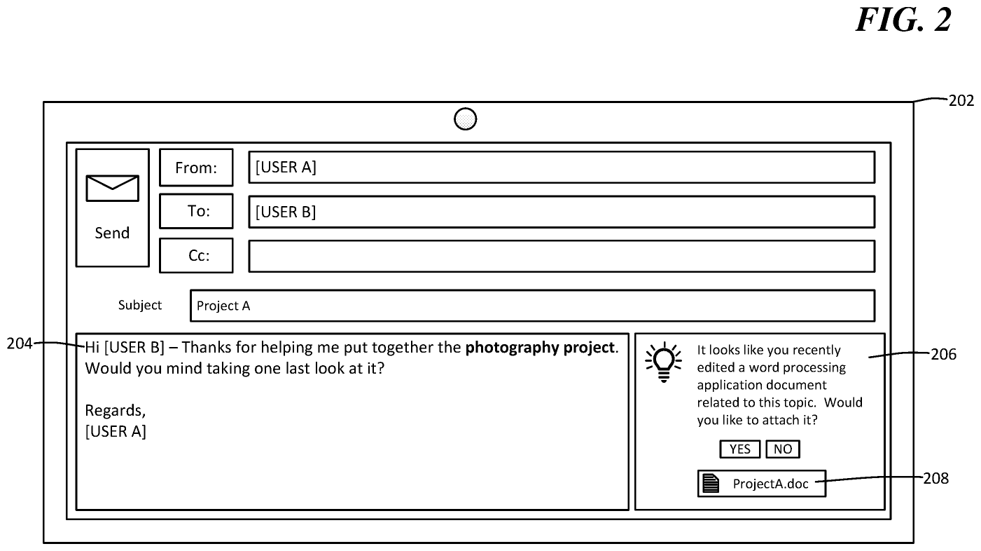

FIG. 2 illustrates a computing device 202 displaying an email user interface including a collaborative resource recommendation pane 206. The email user interface comprises an email that is being composed. The email includes [USER A] in the “From” field and [USER B] in the “To” field. The subject of the email is “Project A”. The body 204 of the email states: “Hi [USER B]—Thanks for helping me put together the photography project. Would you mind taking one last look at it? Regards, [USER A].”

According to examples, the email application that [USER A] is using to author the email may be associated with the resource collaboration service. As such, the resource collaboration service may apply one or more natural language processing and/or machine learning models to the email message while it is being authored, when it is completed, and/or after it has been sent. For example, the resource collaboration service may apply one or more of these models at periodic intervals during the authoring of the email (e.g., every second, every ten seconds, every minute, etc.), after the email has remained static (e.g., hasn't been edited) for a specified period of time, when the email is saved, etc. In additional examples, the models may be applied to the email itself as well as the content of any attachments that are included with the email. The one or more natural language processing and/or machine learning models applied to the message may be applied to identify topical categories that the email relates to so that the email can be categorized as a resource/node in a graphical matrix comprised of a plurality of resources and joined to one or more of those other resources/nodes based on shared topical attributes.

In additional examples, the resource collaboration service may extract user identities from the email (e.g., sender, receiver, users that are Cced, users that are referenced in the body 204, etc.), match those user identities with user accounts that it has access to, identify characteristics of those users from the user accounts, and categorize and/or group the users based on their characteristics. In some examples, these characteristic-based categorizations may be utilized in association with the topical categorizations to build edges and connect resources in a graphical matrix. In other examples, these characteristic-based categorizations may be utilized separate from the topical categorizations for recommending that users collaborate with one another in relation to one or more resources.

In this example, the resource collaboration service causes collaborative resource recommendation pane 206 to be surfaced based on the processing of the email. Specifically, the email has been topically categorized based on the natural language processing and/or machine learning models that have been applied to it, the email has been added to a graph of existing resources/nodes, and the email has been connected to one or more of those resources/nodes in the graph based on its topical categorization. In some examples, the email may also be connected to one or more resources/nodes in the graph based on the user characteristics categorizations. Thus, in this example, collaborative resource recommendation pane 206 includes the text “It looks like you recently edited a word processing application document related to this topic. Would you like to attach it?”—“YES”, “NO”. Collaborative resource recommendation pane 206 also includes a display element corresponding to the referenced document (i.e., “ProjectA.doc”). In some examples, that display element may be interacted with (e.g., drag and drop, double clicked, etc.) to initiate its attachment to the email. The “YES” and “NO” user interface elements in the collaborative resource recommendation pane 206 may also be selectable for initiating the attachment of the referenced document to the email.

It should be understood that the user interface layout and the elements described in relation to the collaborative resource recommendation pane 206 are provided in the arrangement shown in relation to FIG. 2 for illustrative purposes only. Other arrangements are contemplated, as are different element names, types, and mechanisms of action for surfacing related documents and including them as attachments and/or opening them.

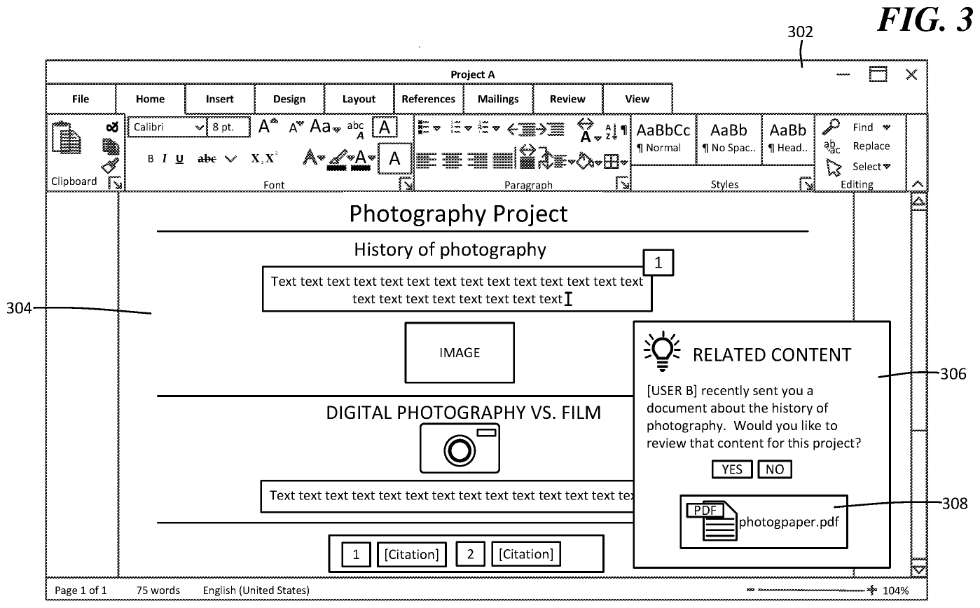

FIG. 3 illustrates a word processing application user interface 302 including a collaborative resource recommendation pane 306 that can be interacted with for opening and reviewing a resource that is topically related to a document 304 displayed in the word processing user interface. Document 304 includes a plurality of objects and sets of text related to the heading “Photography Project”.

According to examples, the word processing application may be associated with the resource collaboration service. As such, the resource collaboration service may apply one or more natural language processing and/or machine learning models to document 304 to topically categorize its content. In this example, document 304 also includes a plurality of citations. The resource collaboration service may thus attempt to locate the sources corresponding to those citations (e.g., via automated internet search, via an automated resource database search) and it may perform additional processing to topically categorize the content of those sources. According to some examples, the text in document 304 may be categorized based on application of one or more natural language processing models (e.g., a topic detection model) and the images embedded in document 304 may be topically classified based on application of one or more machine learning models (e.g., a neural network trained to identify and categorize images). In examples, when one or more topics have been identified for document 304, those topics may be associated as attributes with document 304. In some examples, the topical attributes may be associated with document 304 as searchable metadata. In additional examples, document 304 may be included in a graphical matrix of resources/nodes and associated with one or more of those other resources/nodes based on shared topical attributes. In still other examples, the resource collaboration service may identify a user account associated with the author/owner of document 304 and identify one or more characteristics associated with that user and her corresponding user account (e.g., via service store 112). Those characteristics may also be associated with document 304 as searchable metadata and/or utilized in creating connections/edges to other resources/nodes in a graphical resource matrix.

In this example, the resource collaboration service causes collaborative resource recommendation pane 306 to be surfaced based on the processing of document 304. Specifically, document 304 has been topically categorized based on the natural language processing and/or machine learning models that have been applied to it (and in some examples one or more of the citation sources), document 304 has been added to a graph of existing resources/nodes, and document 304 has been connected to one or more of those resources/nodes in the graph based on its topical categorization. In some examples, document 304 may also be connected to one or more resources/nodes in the graph based on the user characteristics categorizations of the author/owner. Thus, in this example, collaborative resource recommendation pane 306 includes the text: “[USER B] recently sent you a document about the history of photography. Would you like to review that content for this project?”—“YES”, “NO”. Collaborative resource recommendation pane 306 also includes a display element 308 corresponding to the referenced document (i.e., “photogpaper.pdf”). In some examples, display element 308 may be interacted with (e.g., double clicked, touch input, etc.) to initiate the opening and/or previewing of the corresponding document. The “YES” and “NO” user interface elements in collaborative resource recommendation pane 306 may also be selectable for initiating the opening and/or previewing of the document corresponding to display element 308.

It should be understood that the user interface layout and the elements described in relation to the collaborative resource recommendation pane 306 are provided in the arrangement shown in relation to FIG. 3 for illustrative purposes only. Other arrangements are contemplated, as are different element names, types, and mechanisms of action for surfacing related documents and opening and/or previewing them.

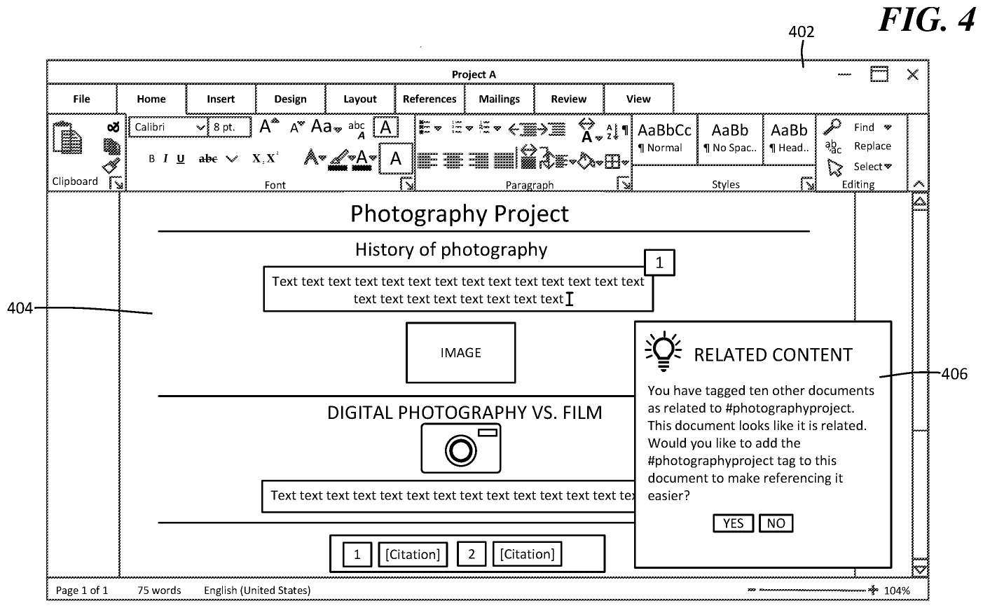

FIG. 4 illustrates a word processing application user interface 402 including a collaborative resource recommendation pane 406 that can be interacted with for tagging a document based on its topical classification. Document 404 is the same document as document 304 discussed above in relation to FIG. 3. However, in this example, a user is provided with an option to manually tag document 404 with a searchable tag in addition or alternatively to the resource collaboration service automatically associating topical categories with it. Thus, in this example, the resource collaboration service has determined (e.g., based on application of one or more natural language processing and/or machine learning models) that document 406 likely relates to one or more topical categories that a plurality of other resources have already been associated with. Those resources have previously been tagged (manually or automatically) with the #photographyproject tag. Tags such as #photographyproject may be associated with resources as searchable metadata. Those tags may thus be utilized to identify resources in addition or alternatively to automatic topical categorizations that have been applied by the resource collaboration service. In this example, because of the topical overlap between document 404 and the other tagged documents, the resource collaboration service surfaces collaborative resource recommendation pane 406, which states: “RELATED CONTENT”—“You have tagged ten other documents as related to #photographyproject. This document looks like it is related. Would you like to add the #photographyproject tag to this document to make referencing it easier?”—“YES”, “NO”. The “YES” and “NO” user interface elements in collaborative resource recommendation pane 406 may be selectable for manually tagging document 404 with the #photographyproject tag that has been suggested based on the topical relationship that has been identified between document 404 and at least a threshold number of the ten other documents referenced in collaborative resource recommendation pane 406.

It should be understood that the user interface layout and the elements described in relation to the collaborative resource recommendation pane 406 are provided in the arrangement shown in relation to FIG. 4 for illustrative purposes only. Other arrangements are contemplated, as are different element names, types, and mechanisms of action for surfacing and/or associating recommended tags with resources. For example, an option for manually selecting, inputting and/or associating a document tag with document 404 may be provided in a toolbar of the word processing application and/or in a drop-down menu of the word processing application.

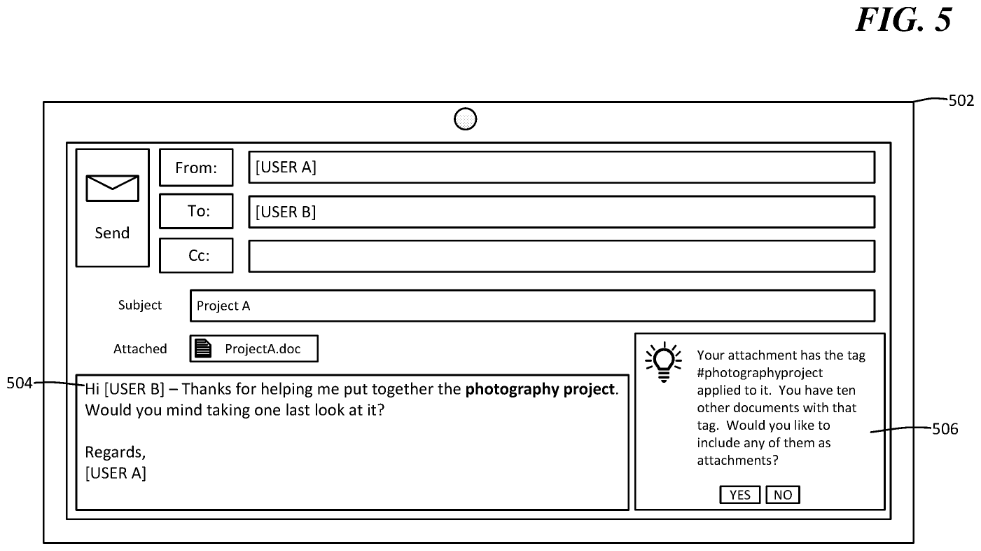

FIG. 5 illustrates a computing device 502 displaying an email user interface including a collaborative resource pane 506 that can be interacted with for surfacing and sharing resources that are topically related to an email displayed in the email user interface. The email user interface comprises an email that is being composed. The email includes [USER A] in the “From” field and [USER B] in the “To” field. The subject of the email is “Project A”. The body 504 of the email states: “Hi [USER B]—Thanks for helping me put together the photography project. Would you mind taking one last look at it? Regards, [USER A].”

In this example, the document discussed above in relation to FIG. 4 was associated with the #photographyproject tag, and that document has now been attached to the email displayed on computing device 502. The resource collaboration service, which is associated with the email application and the word processing application, surfaces collaborative resource pane 506 in the email application user interface, which states: “Your attachment has the tag #photographyproject applied to it. You have ten other documents with that tag. Would you like to include any of them as attachments?”—“YES”, “NO”. Thus, in this example, rather than surfacing a selectable option/recommendation for attaching/sharing documents with another user based on attributes corresponding to automatically identified topical categories, the resource collaboration service is surfacing a selectable option/recommendation for attaching/sharing documents based on the tag that has been manually assigned to the word processing document from FIG. 4 and the ten other documents that the same tag was associated with.

It should be understood that the user interface layout and the elements described in relation to the collaborative resource recommendation pane 506 are provided in the arrangement shown in relation to FIG. 5 for illustrative purposes only. Other arrangements are contemplated, as are different element names, types, and mechanisms of action for surfacing recommendations to attach/share documents based on tags.

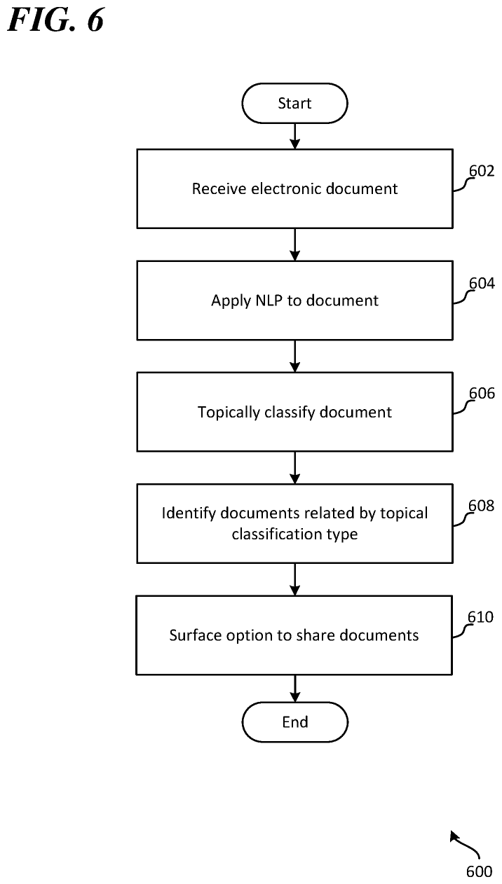

FIG. 6 is an exemplary method 600 for sharing collaborative documents. The method 600 begins at a start operation and flow continues to operation 602.

At operation 602 an electronic document is received. According to examples, the electronic document may comprise: a word processing document, a spreadsheet document, a presentation document, a notes document, an electronic message (e.g., an email, an instant message), or any other productivity application document. According to examples, the electronic document may be received and/or processed by a productivity application and/or a resource collaboration service. The electronic document may be received and processed locally and/or remotely.

From operation 602 flow continues to operation 604 where a natural language processing model is applied to the electronic document. The natural language processing model may comprise one or more of: a topic detection model using clustering; a hidden Markov model; a conditional random field model; a support vector machine model; a decision tree model; a deep neural network model; a general sequence-to-sequence model; a generative model; a recurrent neural network for feature extraction model; a deep neural network for word-by-word classification model; and a latent variable model. In some examples, a neural network model may be applied to image objects included in the electronic document to classify those objects based on type. In some examples, applying a topic detection model using clustering may comprise: creating a list of keywords/phrases; identifying clusters of those keywords/phrases that are defined as the center for various topics (i.e., defining a baseline); receiving a document; extracting keywords/phrases form the document; and classifying the document based on the relative similarity and/or closeness of the extracted keywords/phrases to the defined centers.

From operation 604 flow continues to operation 606 where the electronic document is topically classified based on the application of the natural language processing model. The topical classification may comprise one or more classification types and/or sub-types that are associated with the document. Classification types may include categories such as: sports, politics, news, biology, chemistry, pop culture, etc. Sub-categories may include more defined subject matter (e.g., sports-football-team-location-year, etc.). According to examples, the classification types may be associated with the electronic document as attributes. The attributes may be associated with the electronic document as searchable metadata. According to some examples, the electronic document may be added to an existing graphical resource matrix and connected to existing resources/nodes therein based on the attributes.

From operation 606 flow continues to operation 608 where a plurality of electronic documents that are related to the electronic document are identified based on a same topical classification. For example, if the electronic document is associated/classified as relating to “category A” and a second document is associated/classified as relating to “category A”, the first and second documents may each be assigned a “relatedness” score to one another. In additional examples, if both of those documents share the “category A” designation as well as an additional categorization and/or sub-categorization, a higher “relatedness” score may be assigned to those documents.

From operation 608 flow continues to operation 610 where a selectable option to share the electronic document and one or more of the plurality of additional electronic documents is surfaced. In some examples, the selectable option may comprise an option to attach the electronic to an email. In other examples, the selectable option may comprise an option to send the electronic document via an electronic message (e.g., email, instant message, etc.). In still other examples, the selectable option may comprise an option to provide a user with access to the electronic document (e.g., grant viewing privileges, grant editing privileges, etc.). In additional examples, the selectable option may comprise an option to upload the electronic document to a shared folder and/or drive.

From operation 610 flow moves to an end operation and the method 600 ends.

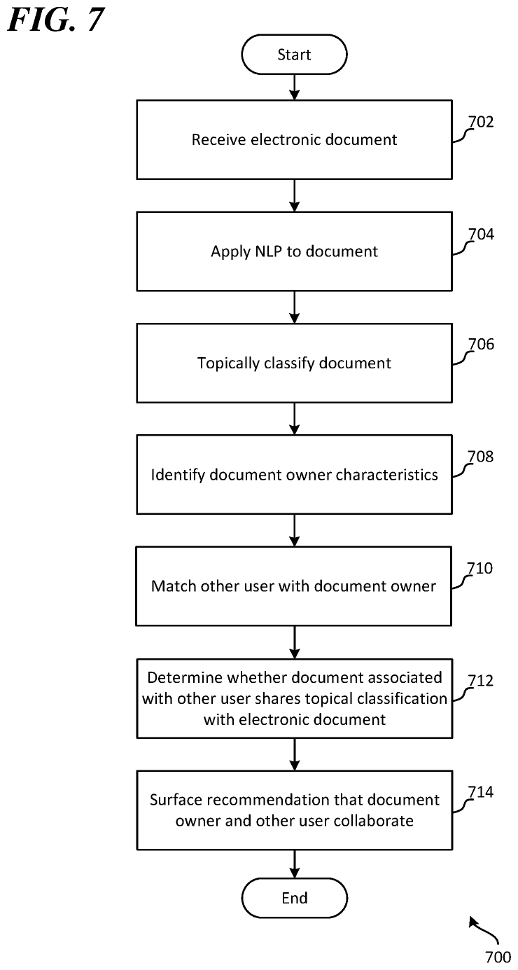

FIG. 7 is an exemplary method 700 for recommending group collaboration. The method 700 begins at a start operation and flow moves to operation 702.

At operation 702 an electronic document is received. According to examples, the electronic document may comprise: a word processing document, a spreadsheet document, a presentation document, a notes document, an electronic message (e.g., an email, an instant message), or any other productivity application document. According to examples, the electronic document may be received and/or processed by a productivity application and/or a resource collaboration service. The electronic document may be received and processed locally and/or remotely.

From operation 702 flow continues to operation 704 where a natural language processing model is applied to the electronic document. The natural language processing model may comprise one or more of: a topic detection model using clustering; a hidden Markov model; a conditional random field model; a support vector machine model; a decision tree model; a deep neural network model; a general sequence-to-sequence model; a generative model; a recurrent neural network for feature extraction model; a deep neural network for word-by-word classification model; and a latent variable model. In some examples, a neural network model may be applied to image objects included in the electronic document to classify those objects based on type.

From operation 704 flow continues to operation 706 where the electronic document is topically classified based on application of the natural language processing model. The topical classification may comprise one or more classification types and/or sub-types that are associated with the document. Classification types may include categories such as: sports, politics, news, biology, chemistry, pop culture, etc. Sub-categories may include more defined subject matter (e.g., sports-football-team-location-year, etc.). According to examples, the classification types may be associated with the electronic document as attributes. The attributes may be associated with the electronic document as searchable metadata. According to some examples, the electronic may be added to an existing graphical resource matrix and connected to existing resources/nodes therein based on the attributes.

From operation 706 flow continues to operation 708 where a plurality of characteristics associated with an owner of the electronic document are identified. In some examples, the characteristics may be identified from a service store associated with one or more productivity applications (e.g., a suite of applications). In other examples, the characteristics may be provided by the users directly to the resource collaboration service. In examples the plurality of characteristics may comprise two or more of: educational information (e.g., class of enrollment, educational major of enrollment, educational minor of enrollment), work information (e.g., work group, work level/hierarchy, etc.), locational information, age information, gender information, collaboration and other service-based preference information, etc.

From operation 708 flow continues to operation 710 where at least one other user is matched with the owner of the electronic document based at least on having one of the plurality of characteristics in common with the owner of the electronic document. For example, the one other user may share an educational class of enrollment; an educational major of enrollment; an educational minor of enrollment; an area of educational instruction (e.g., bio-chemistry, physics); a school of educational instruction (e.g., department classifications, college of medicine, college of business); and a field of expertise (e.g., quantum computing, artificial intelligence), etc. with the owner of the electronic document.

From operation 710 flow continues to operation 712 where a determination is made as to whether at least one electronic document associated with the at least one other user shares a topical classification with the electronic document. That is, one or more documents associated with the at least one other user may have been topically categorized (e.g., via application of one or more natural language processing and/or machine learning models) and included in a graphical resource matrix and/or a topical classification lookup table.

From operation 712 flow continues to operation 714 where a recommendation that the owner of the electronic document and the at least one other user collaborate with one another is surfaced. The recommendation may be provided to one or multiple of the users. In some examples, the recommendation may be included in an email or other electronic message. In other examples, the recommendation may be surfaced in association with one of the documents that share a topical categorization. In still other examples, the recommendation may be surfaced in association with any document in a productivity application of any of the users that share a characteristic and/or a document with a topical categorization.

From operation 714 flow continues to an end operation and the method 700 ends.

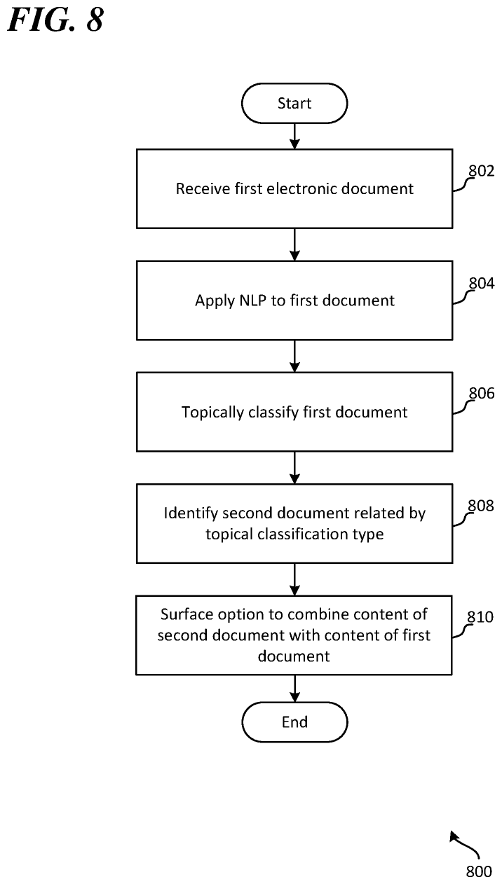

FIG. 8 is an exemplary method 800 for assisting with sharing collaborative documents. The method 800 begins at a start operation and flow moves to operation 802.

At operation 802 a first electronic document is received. According to examples, the first electronic document may comprise: a word processing document, a spreadsheet document, a presentation document, a notes document, an electronic message (e.g., an email, an instant message), or any other productivity application document. According to examples, the first electronic document may be received and/or processed by a productivity application and/or a resource collaboration service. The first electronic document may be received and processed locally and/or remotely.

From operation 802 flow continues to operation 804 where a natural language processing model is applied to the first electronic document. The natural language processing model may comprise one or more of: a topic detection model using clustering; a hidden Markov model; a conditional random field model; a support vector machine model; a decision tree model; a deep neural network model; a general sequence-to-sequence model; a generative model; a recurrent neural network for feature extraction model; a deep neural network for word-by-word classification model; and a latent variable model. In some examples, a neural network model may be applied to image objects included in the first electronic document to classify those objects based on type.

From operation 804 flow continues to operation 806 where the first electronic document is topically classified based on the application of the natural language processing model to the first electronic document. The topical classification may comprise one or more classification types and/or sub-types that are associated with the document. Classification types may include categories such as: sports, politics, news, biology, chemistry, pop culture, etc. Sub-categories may include more defined subject matter (e.g., sports-football-team-location-year, etc.). According to examples, the classification types may be associated with the first electronic document as attributes. The attributes may be associated with the first electronic document as searchable metadata. According to some examples, the first electronic document and its corresponding attributes may be added to an existing graphical resource matrix and connected to existing resources/nodes therein based on the attributes.

From operation 806 flow continues to operation 808 where a second electronic document that is related to the first electronic document is identified based on having a same classification type as the first electronic document. That is, the second electronic document may have been topically classified in a same or similar manner as described above with regard to the first electronic document, and one or more of the classification types of the first and second electronic documents may be determined to be the same. In some examples, the matching may be made via a graphical resource matrix that both electronic documents have been added to. In other examples, the matching may be made via one or more topical classification lookup tables.

From operation 808 flow continues to operation 810 where a selectable option to combine content of the second electronic document with content of the first electronic document is surfaced. In some examples, the selectable option to combine may comprise an option to open, preview and/or review the second document. In other examples, the selectable option to combine may comprise an option to copy and paste and/or otherwise incorporate a portion of the second electronic document in the first electronic document. The selectable option to combine may be surfaced in an electronic message addressed to an owner of the first electronic document. In other examples, the selectable option to combine may be surfaced in an application user interface corresponding to an application of the first electronic document.

From operation 810 flow continues to an end operation and the method 800 ends.

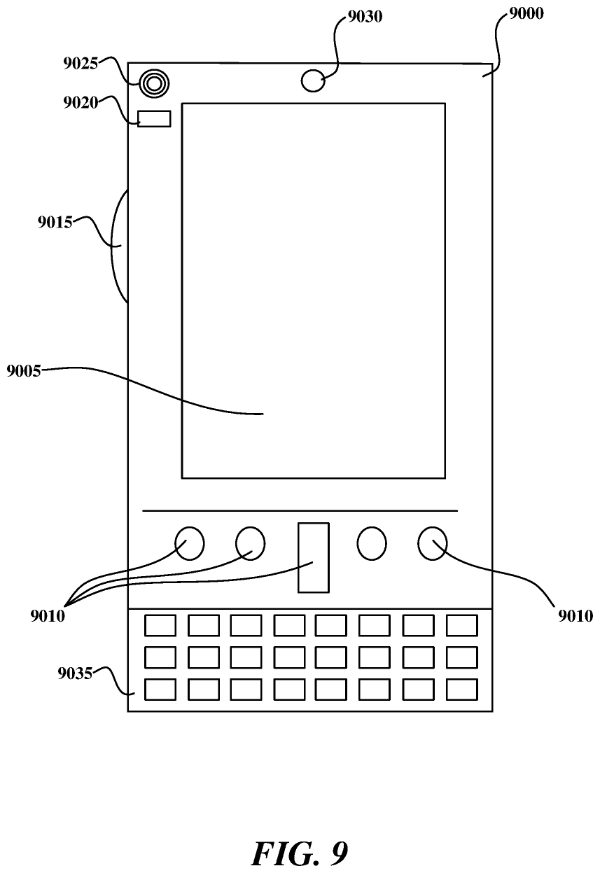

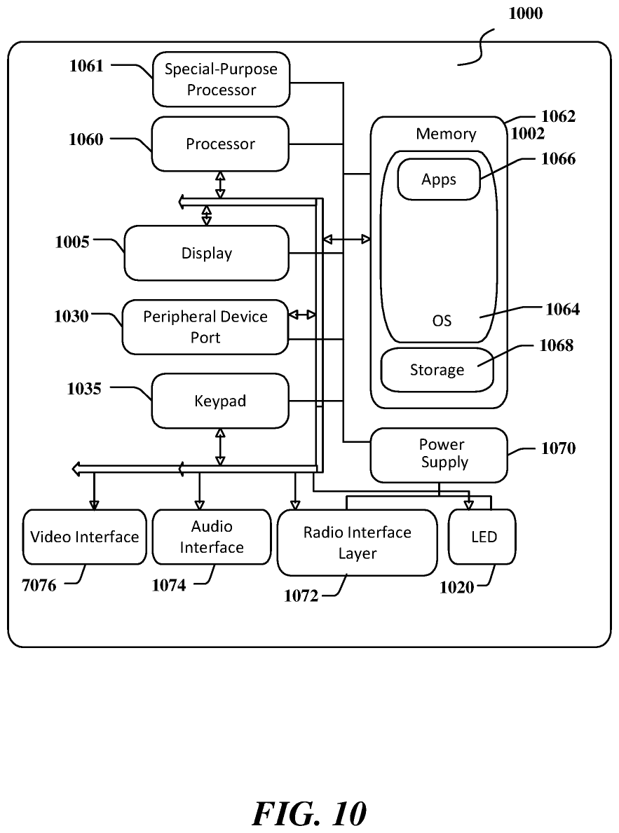

FIGS. 9 and 10 illustrate a mobile computing device 900, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 9, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or fewer input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 10 is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000, including instructions for providing and operating a digital assistant computing platform.

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 920 may be used to provide visual notifications, and/or an audio interface 1074 may be used for producing audible notifications via the audio transducer 925. In the illustrated embodiment, the visual indicator 920 is a light emitting diode (LED) and the audio transducer 925 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 925, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an on-board camera 930 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

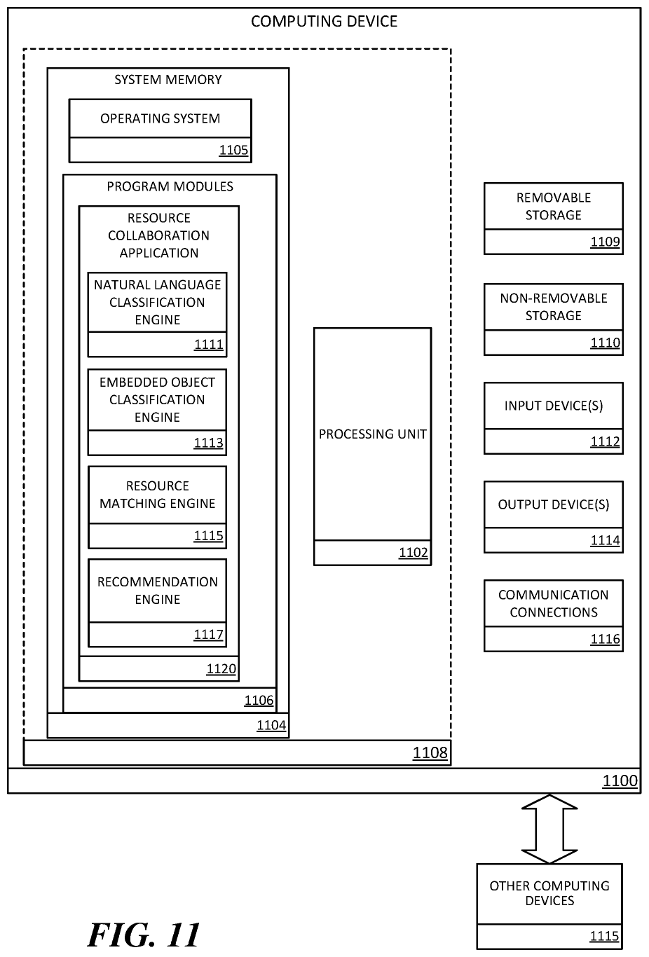

FIG. 11 is a block diagram illustrating physical components (e.g., hardware) of a computing device 1100 with which aspects of the disclosure may be practiced. The computing device components described below may have computer executable instructions for generating, surfacing and providing operations associated with resource collaboration. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 suitable for running one or more digital assistant programs. The operating system 1105, for example, may be suitable for controlling the operation of the computing device 1100. Furthermore, embodiments of the disclosure may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., resource collaboration application 1120) may perform processes including, but not limited to, the aspects, as described herein. According to examples, natural language classification engine 1111 may perform one or more operations associated with applying one or more natural language processing models (e.g., topical classification models) to text in a resource to classify a document by topic. Embedded object classification engine 1113 may perform one or more operations associated with applying one or more machine learning models (e.g., neural networks) to embedded objects in resources to classify the objects and resources by topic type. Resource matching engine 1115 may perform one or more operations associated with identifying relationships amongst resources based on topical overlap of those resources and/or user characteristic overlap associated with those resources. Recommendation engine 1117 may perform one or more operations associated with surfacing resource collaboration recommendations and/or group recommendations.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, etc. The output device(s) 1114 such as a display, speakers, a printer, etc. may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

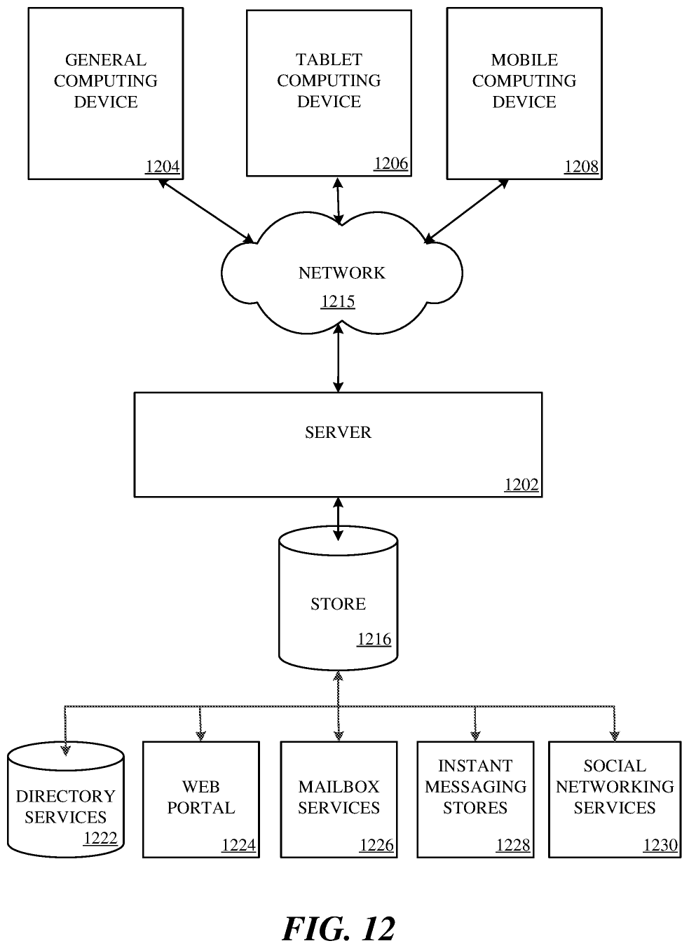

FIG. 12 illustrates one aspect of the architecture of a system for processing data received at a computing system from a remote source, such as a personal/general computer 1204, tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking site 1230. The program modules 1106 may be employed by a client that communicates with server device 1202, and/or the program modules 1106 may be employed by server device 1202. The server device 1202 may provide data to and from a client computing device such as a personal/general computer 1204, a tablet computing device 1206 and/or a mobile computing device 1208 (e.g., a smart phone) through a network 1215. By way of example, the computer systems described herein may be embodied in a personal/general computer 1204, a tablet computing device 1206 and/or a mobile computing device 1208 (e.g., a smart phone). Any of these embodiments of the computing devices may obtain content from the store 1216, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for sharing collaborative documents, the method comprising:
receiving an electronic document;
applying a natural language processing model to the electronic document;
topically classifying the electronic document based on the application of the natural language processing model;
identifying a plurality of additional electronic documents that are related to the electronic document based on a same topical classification type; and
surfacing a selectable option to share the electronic document and one or more of the plurality of additional electronic documents.

2. The method of claim 1, further comprising surfacing a selectable option to combine content of at least one of the plurality of additional electronic documents with content of the electronic document.

3. The method of claim 1, further comprising determining, based on application of the natural language processing model to the electronic document, that the electronic document is collaborative in nature.

4. The method of claim 1, further comprising
identifying a folder containing a plurality of electronic documents, wherein the folder contains a threshold percentage of electronic documents that are related to the electronic document based on a same topical classification; and
surfacing a selectable option to share the folder.

5. The method of claim 1, wherein the plurality of additional electronic documents is identified based on being included in a folder that contains a threshold percentage of electronic documents that are related to the electronic document based on a same topical classification.

6. The method of claim 5, wherein the surfacing of the selectable option to share the one or more of the plurality of additional electronic documents comprises a selectable option to share the entirety of the folder.

7. The method of claim 1, further comprising:
identifying a plurality of characteristics associated with an owner of the electronic document; and
matching the owner of the electronic document with at least one other user based on an overlap of the owner's characteristics and characteristics of the at least one other user.

8. The method of claim 7, wherein the characteristics comprise one or more of: an educational class of enrollment; an educational major of enrollment; an educational minor of enrollment; an area of educational instruction; a school of educational instruction; and a field of expertise.

9. The method of claim 7, wherein the selectable option to share the electronic document and one or more of the plurality of additional documents is selectable for sharing the electronic document and one or more of the plurality of additional documents with the at least one matched user.

10. The method of claim 1, wherein the natural language processing model comprises one of: a topic detection model using clustering; a hidden Markov model; a conditional random field model; a support vector machine model; a decision tree model; a deep neural network model; a general sequence-to-sequence model; a generative model; a recurrent neural network for feature extraction model; a deep neural network for word-by-word classification model; and a latent variable model.

11. A method for recommending group collaboration, comprising:
receiving an electronic document;
applying a natural language processing model to the electronic document;
topically classifying the electronic document based on application of the natural language processing model;
identifying a plurality of characteristics associated with an owner of the electronic document;
matching at least one other user with the owner of the electronic document based at least on having one of the plurality of characteristics in common with the owner of the electronic document; and
determining whether at least one electronic document associated with the at least one other user shares a topical classification with the electronic document; and
surfacing a recommendation that the owner of the electronic document and the at least one other user collaborate.

12. The method of claim 11, wherein the surfaced recommendation is a recommendation to collaborate on a subject corresponding to the topical classification.

13. The method of claim 11, wherein the characteristic that is in common with the owner of the electronic document and the at least one other user comprises one of: an educational class of enrollment; an educational major of enrollment; an educational minor of enrollment; an area of educational instruction; a school of educational instruction; and a field of expertise.

14. The method of claim 11, wherein the natural language processing model comprises one of: a topic detection model using clustering; a hidden Markov model; a support vector machine model; a conditional random field model; a decision tree model; a deep neural network model; a general sequence-to-sequence model; a generative model; a recurrent neural network for feature extraction model; a deep neural network for word-by-word classification model; and a latent variable model.

15. A computer-readable storage device comprising executable instructions that, when executed by one or more processors, assist with sharing collaborative documents, the computer-readable storage device including instructions executable by the one or more processors for:
receiving a first electronic document;
applying a language processing model to the first electronic document;
assigning a scored value to each of a plurality of linguistic features of the first electronic document based on application of the language processing model;
comparing the scored value for each of the plurality of linguistic features of the first electronic document with scored values for each of a plurality of linguistic features of a second electronic document;
determining whether the first electronic document and the second electronic document meet a minimum similarity score threshold value based on the comparison; and
surfacing a collaboration recommendation related to the first electronic document and the second electronic document if a determination is made that the minimum similarity score threshold value has been met

16. The computer-readable storage device of claim 15, wherein the collaboration recommendation comprises a selectable option to combine content of the second electronic document with content of the first electronic document.

17. The computer-readable storage device of claim 15, wherein the collaboration recommendation comprises a selectable option to share first electronic document and the second electronic document.

18. The computer-readable storage device of claim 16, wherein the instructions are further executable by the one or more processors for:
identifying a folder containing a plurality of electronic documents, wherein the folder contains a threshold percentage or number of electronic documents that are related to the first electronic document based on a calculated similarity score between each of those documents and the first electronic document; and
surfacing a selectable option to share the folder.

19. The computer-readable storage device of claim 15, wherein the second electronic document is identified based on being included in a folder that contains a threshold percentage or number of electronic documents that are related to the electronic document based on meeting a minimum threshold similarity score.

20. The computer-readable storage device of claim 15, wherein the instructions are further executable by the one or more processors for:
identifying a plurality of characteristics associated with an owner of the first electronic document; and
matching the owner of the first electronic document with at least one other user based on an overlap of the owner's characteristics and characteristics of the at least one other user.
